(19) United States
(12) Patent Application Publication
(10) Pub. No.: US 2014/0019573 A1
(43) Pub. Date: Jan. 16, 2014

(54) SOURCE REFERENCE REPLICATION IN A DATA STORAGE SUBSYSTEM

(71) Applicant: Jeremy Dean Swift, Plymouth, MN (US)

(72) Inventor: Jeremy Dean Swift, Plymouth, MN (US)

(73) Assignee: Compellent Technologies, Eden Prairie, MN (US)

(21) Appl. No.: 13/550,294

(22) Filed: Jul. 16, 2012

(51) Int. Cl. G06F 15/167

(52) U.S. Cl. 709/212

(57) ABSTRACT

A method of data replication from a first data storage device to a second data storage device. According to the method, prior to replicating data from the first data storage device to the second data storage device, metadata relating to data to be replicated may be transmitted to the second data storage device, the metadata including information about the data to be replicated and a path identifier identifying a path through which the second data storage device can remotely access the data at the first data storage device until the data to be replicated is copied to the second data storage device.

### FIELD OF THE INVENTION

The present disclosure generally relates to systems and methods for data replication. Particularly, the present disclosure relates to source reference replication in a data storage subsystem or information handling system.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As more and more information or data is being stored and processed electronically in such information handling systems, means for keeping the data secure, quickly accessible, and fault-tolerant have become increasingly important. Similarly, increasing regulation on the storage of corporate data has led to more scrutiny in maintenance and protection of that data.

Data replication involves a process of sharing information or data so as to ensure consistency between redundant resources and improve reliability, fault-tolerance, and/or accessibility. In many cases, replication may be extended across a computer network, such as the Internet, so that physical storage devices can be located in physically remote locations. One purpose of data replication is to prevent damage from failures or disasters that may occur in one location, or in case such events do occur, improve the ability to recover. Another purpose of data replication is to permit local access to the same data at multiple locations.

However, conventional asynchronous replication techniques typically require the replication data be sent from the source system or site to the destination system or site before the data can be utilized at the destination site, as the destination site knows nothing about the replication data, until the data has actually arrived at the destination site. This technique makes the replication of large amounts of data extremely arduous, as it can take an extremely long time to replicate the entirety of the data to the destination site over a network. The process can become so time consuming, that portable disks are often used to physically transport the large amounts of data to the destination site rather than using networks for the transmission.

Thus, there is a need in the art for providing more cost effective and/or more efficient data replication processes. More particularly, there is a need in the art for, what is referred to herein as, source reference replication.

### BRIEF SUMMARY OF THE INVENTION

The present disclosure, in one embodiment, relates to a method of data replication from a first data storage device to a second data storage device. According to the method, prior to replicating data from the first data storage device to the second data storage device, metadata relating to data to be replicated may be transmitted to the second data storage device, the metadata including information about the data to be replicated and a path identifier identifying a path through which the second data storage device can remotely access the data at the first data storage device until the data to be replicated is copied to the second data storage device. In one embodiment, the metadata may be transmitted via a computer network. The first data storage device may be located at a source site, and the second data storage device may be located a remote destination site. Upon request from a user to the destination site to access the data to be replicated when the data to be replicated has not yet been copied to the second data storage device, the data may be remotely accessed at the first data storage device utilizing the path identifier provided in the metadata. The method may further include retrieving and locally storing a copy of the data accessed utilizing the path identifier, and indicating in the metadata that such data has been replicated to the second data storage device. The source site may also be notified that the retrieved data has been replicated to the second data storage device. The method may further include subsequently copying the data to be replicated to the second data storage system. In some embodiments, however, only the portion of the data to be replicated that has not been identified as already retrieved and replicated to the second data storage device may be copied to the second data storage device.

The present disclosure, in another embodiment, relates to an information handling system having a first data storage subsystem and a second data storage subsystem, the first data storage subsystem including data to be replicated to the second data storage subsystem, and the second data storage subsystem including metadata including information about the data to be replicated and a path identifier for remotely accessing the data at the first data storage subsystem until the data to be replicated is copied to the second data storage subsystem. The first data storage subsystem and second data storage subsystem may be remotely connected via a computer network, and the metadata at the second data storage subsystem may have been transmitted from the first data storage subsystem via the network. Upon request from a user to the second data storage subsystem for access to the data to be replicated, the data at the first data storage subsystem may be accessed by the second data storage subsystem via the computer network utilizing the path identifier provided in the metadata. Data accessed by the second data storage subsystem via the computer network utilizing the path identifier provided in the metadata may be retrieved and locally stored at the second data storage subsystem, and the metadata may be updated to reflect that such data has been replicated to the second data storage subsystem. For the data retrieved and locally stored at the second data storage subsystem, the first data storage subsystem may also be notified that the retrieved data has been replicated to the second data storage subsystem. During a subsequent replication process for the data to be replicated, wherein the data to be replicated is copied to the second data storage subsystem, the data previously retrieved and locally stored at the second data storage subsystem may be removed from the replication process, so as not be recopied to the second data storage subsystem.

The present disclosure, in yet another embodiment, relates to a method for chaining data replication between a plurality of data storage subsystems, the plurality of data storage subsystems having a plurality of source-destination subsystem pairs, such that for each pair a first data storage subsystem is a source and a second data storage subsystem is a destination. The method includes, for each source-destination subsystem pair, prior to replicating data from the first data storage subsystem to the second data storage subsystem, transmitting metadata relating to data to be replicated to the second data storage subsystem, the metadata including information about the data to be replicated and a path identifier identifying at least a portion of a full path through which the second data storage device can remotely access the data until the data to be replicated is copied to the second data storage device. The path portion may include a path to the first data storage subsystem, and any remainder of the full path through which the second data storage device can remotely access the data may include a path identified by metadata at the first data storage subsystem, if necessary. In one embodiment, the first data storage subsystem is a source in a first source-destination subsystem pair and is a destination in a second source-destination subsystem pair, and the path identified by metadata at the first data storage subsystem comprises a path to a third data storage subsystem being a source in the second source-destination subsystem pair. The method may further include copying the data to be replicated to the second data storage system. However, upon request from a user to the second data storage subsystem to access the data to be replicated when the data to be replicated has not yet been copied to the second data storage device, the method may include remotely accessing the data via the full path.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic of a disk drive system suitable with the various embodiments of the present disclosure.

FIG. 2 is a schematic of a system for source reference replication according to one embodiment of the present disclosure.

FIG. 3 is a schematic of a system for source reference replication according to the embodiment of FIG. 2, illustrating a request for data utilizing path information stored in metadata.

FIG. 4 is a schematic of a system for source reference replication according to another embodiment of the present disclosure.

FIG. 5 is a schematic of a system for source reference replication according to the embodiment of FIG. 4, illustrating requests for data utilizing path information stored in metadata.

### DETAILED DESCRIPTION

The present disclosure relates to novel and advantageous systems and methods for data replication. Particularly, the present disclosure relates to novel and advantageous systems and methods for source reference replication in a data storage subsystem or information handling system.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

While the various embodiments are not limited to any particular type of information handling system, the systems and methods of the present disclosure may be particularly useful in the context of a disk drive system, or virtual disk drive system, such as that described in U.S. Pat. No. 7,613,945, titled “Virtual Disk Drive System and Method,” issued Nov. 3, 2009, the entirety of which is hereby incorporated herein by reference. Such disk drive systems allow the efficient storage of data by dynamically allocating user data across a page pool of storage, or a matrix of disk storage blocks, and a plurality of disk drives based on, for example, RAID-to-disk mapping. In general, dynamic allocation presents a virtual disk device or volume to user servers. To the server, the volume acts the same as conventional storage, such as a disk drive, yet provides a storage abstraction of multiple storage devices, such as RAID devices, to create a dynamically sizeable storage device. Data progression may be utilized in such disk drive systems to move data gradually to storage space of appropriate overall cost for the data, depending on, for example but not limited to, the data type or access patterns for the data. In general, data progression may determine the cost of storage in the disk drive system considering, for example, the monetary cost of the physical storage devices, the efficiency of the physical storage devices, and/or the RAID level of logical storage devices. Based on these determinations, data progression may move data accordingly such that data is stored on the most appropriate cost storage available. In addition, such disk drive systems may protect data from, for example, system failures or virus attacks by automatically generating and storing snapshots or point-in-time copies of the system or matrix of disk storage blocks at, for example, predetermined time intervals, user configured dynamic time stamps, such as, every few minutes or hours, etc., or at times directed by the server. These time-stamped snapshots permit the recovery of data from a previous point in time prior to the system failure, thereby restoring the system as it existed at that time. These snapshots or point-in-time copies may also be used by the system or system users for other purposes, such as but not limited to, testing, while the main storage can remain operational. Generally, using snapshot capabilities, a user may view the state of a storage system as it existed in a prior point in time.

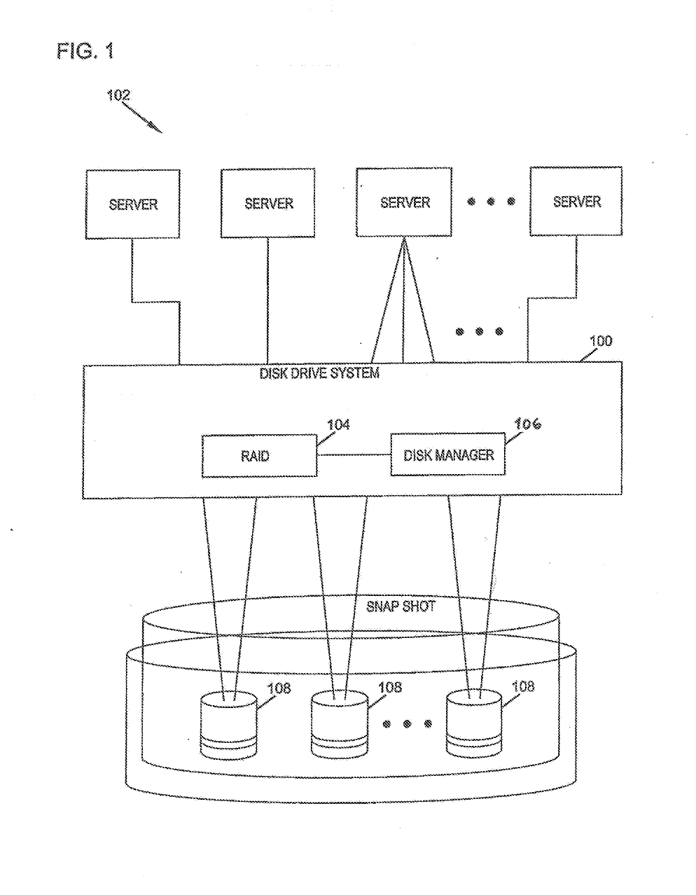

FIG. 1 illustrates one embodiment of a disk drive or data storage system 100 in an information handling system environment 102, such as that disclosed in U.S. Pat. No. 7,613,945, and suitable with the various embodiments of the present disclosure. As shown in FIG. 1, the disk drive system 100 may include a data storage subsystem 104, which may include a RAID subsystem, as will be appreciated by those skilled in the art, and a disk manager 106 having at least one disk storage system controller. The data storage subsystem 104 and disk manager 106 can dynamically allocate data across disk space of a plurality of disk drives 108 based on, for example, RAID-to-disk mapping or other storage mapping technique.

As described above, as more and more information or data is being stored and processed electronically in such systems as those described above, means for keeping the data secure, quickly accessible, and fault-tolerant have become increasingly important. In this regard, data replication provides for the sharing information or data so as to ensure consistency between redundant resources and improve reliability, fault-tolerance, and/or accessibility. However, conventional asynchronous replication techniques typically require the replication data be sent from the source system or site to the destination system or site before the data can be utilized at the destination site, as the destination site knows nothing about the replication data, until the data has actually arrived at the destination site. This technique makes the replication of large amounts of data extremely arduous, as it can take an extremely long time to replicate the entirety of the data to the destination site over a network. The process can become so time consuming and irritating, that portable disks are often used to physically transport the large amounts of data to the destination site rather than using networks for the transmission.

The present disclosure improves replication processes for data stored in a data storage system or other information handling system, such as but not limited to the type of data storage system described in U.S. Pat. No. 7,613,945. Particularly, the present disclosure relates to, what is referred to herein but should not be limited by name as, source reference replication in a data storage subsystem or information handling system. The disclosed improvements can provide more cost effective and/or more efficient data replication processes.

In general, prior to or during replication of data from a source site or system to a destination site or system, source reference replication may involve sending metadata to the destination site, the metadata relating to the data to be, or in the process of being, replicated from the source site to the destination site. For data that has yet to be fully replicated from the source site to the destination site, the transmitted metadata may permit the destination site to reference back to the source location of the data to retrieve the data from the source site, thereby allowing users at the destination site, or users accessing data via the destination site, to access the data to be replicated prior to the actual replication of data being performed or completed.

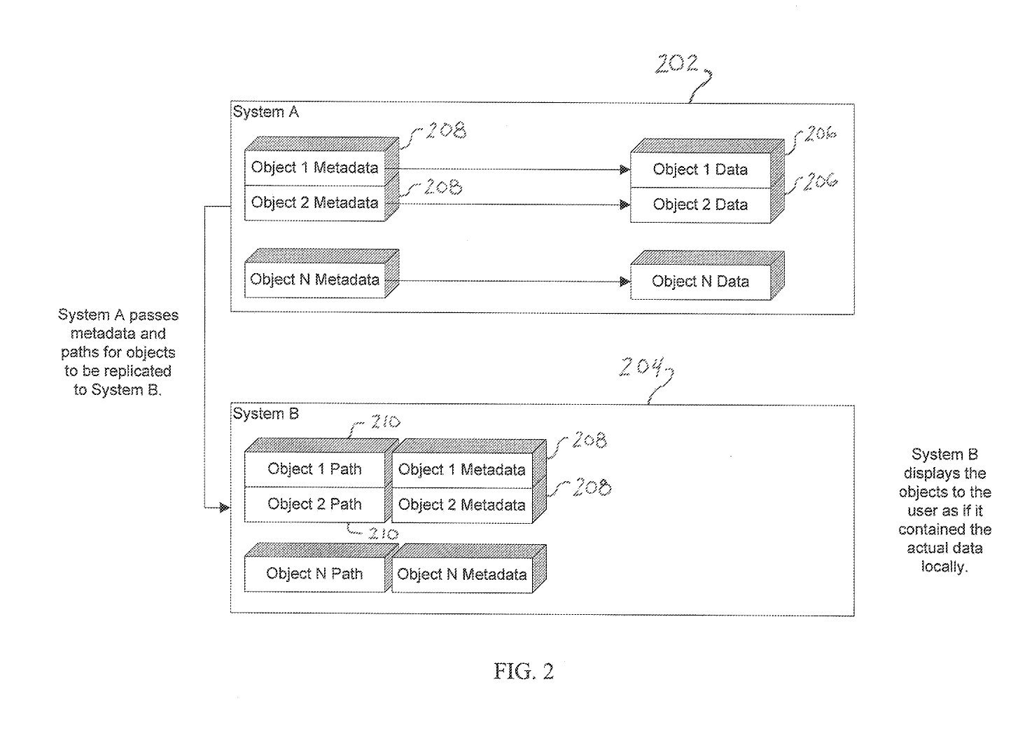

More specifically, according to one embodiment of the present disclosure, as illustrated in FIG. 2, data 206 may be replicated from a source site or system 202 to a destination site or system 204, such as but not limited to, via a network or by physical transport, utilizing portable disks or other portable storage device(s). As will be recognized herein, however, in many cases, the various embodiments of source reference replication described herein may permit more efficient use of replication via a network, for even large amounts of data.

Unlike conventional replication techniques, prior to the data 206 being sent from the source site 202, or at the initial outset of the transfer or even sometime during the transfer, the source site may send metadata 208 to the destination site 204 that provides information about or otherwise describes the corresponding data that will be, or is being, replicated or sent to the destination, as illustrated in FIG. 2. The metadata 208 may include, but is not limited to, names, sizes, permissions, ownership, unique identifiers, or any other desirable or suitable information. The metadata 208 may also include a path or path identifier 210 that identifies the location of, or a path to, the data 206 at the source site 202, and thus can be used or followed by the destination site 204 in order to access the data at the source site until the data has been replicated to the destination site. The metadata 208 transmitted to the destination site 204 will generally be enough to allow the destination site 208 to describe the expected data 206 to any potential user of the data at the destination site, appearing to the user as if the destination site actually stored the data locally, but without, in fact, requiring the data to actually be at the destination site.

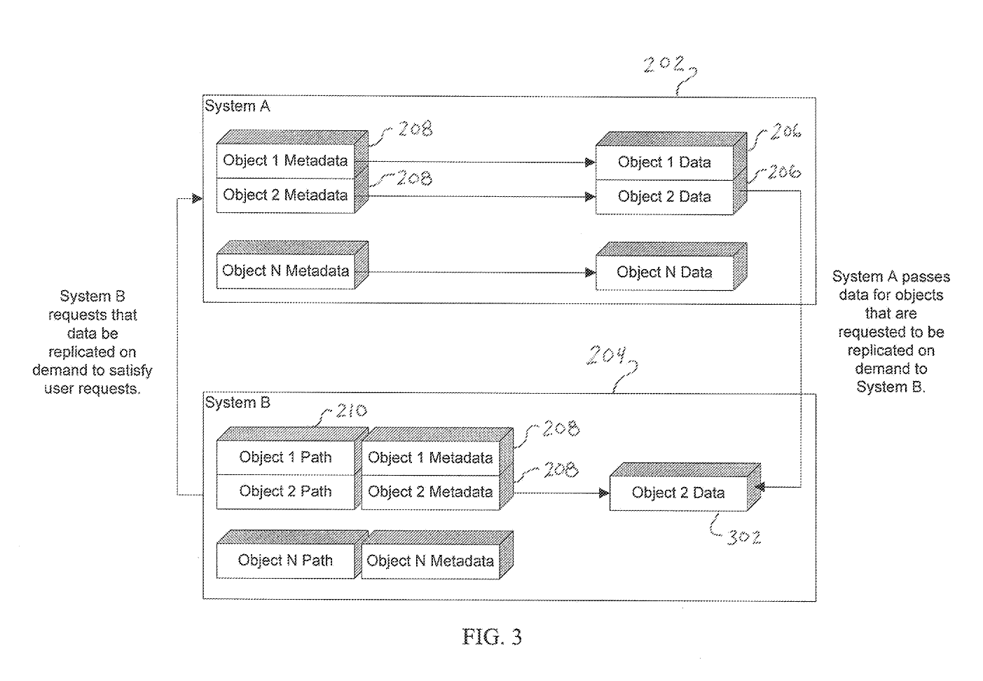

Accordingly, the destination site 204 can generally, at any time during the replication process, present the data to be replicated to its users based on the info' illation available from the sent metadata 208. If a request for the data 206 is made at or through the destination site 204 from one of its users, and the data has not yet been replicated to the destination site, the destination site may utilize the path or path identifier 210, and potentially any other information available from the metadata, to access and retrieve the data 206 from the source site 202, as illustrated in FIG. 3. Any suitable mechanism that has been configured for the system and allows the data to be transmitted in band or out of band to the requesting destination may be utilized, and includes but is not limited to a block interface, a network file system, a web service interface to a cloud, etc.

According to some embodiments, the accessed and retrieved data 206 may be copied 302 and stored locally at the destination site 204 for further local access. In this regard, the destination site 204 can, from then on, present the data to the user locally, and, although not necessary in all embodiments, should change the metadata 208 or other indicator to reflect that the data 206 has been replicated. The source site 202 may also be notified that the data 206 has been replicated so as to avoid the data being sent a second time and wasting bandwidth.

Once the metadata 208 has been sent, or in some embodiments is in the process of being sent, to the destination site 204, the source site 202 may begin transmitting the actual data to be replicated 206 to the destination site. As stated above, data may be replicated from the source site 202 to the destination site via any suitable means, such as via a network or by physical transport. Oftentimes, with conventional replication techniques, with respect to a transfer of large amounts of data, the replication process can become so time consuming and irritating when transferring via a network that portable storage devices are instead often used to physically transport the large amounts of data to the destination site. According to various embodiments of the present disclosure, however, due to the metadata 208 sent by the source site 202 to the destination site 204, the destination site 204 generally has enough information available so as to describe the expected data 206 to any of the potential users of the data at the destination site, appearing to the users as if the data was actually stored and accessible locally at the destination site. Furthermore, should any of the users require access to the data 206 prior to its replication to the destination site 204, the metadata 208 includes a path or path identifier 210 permitting the destination site to remotely access the data at the source site 202 until the data has been replicated to the destination site. In this regard, the actual data replication process can be performed more casually or at a reduced or prioritized pace generally without causing any problematic latency issues. As such, in many cases, the various embodiments of source reference replication described herein may permit more efficient use of replication via a network, for even large amounts of data.

Of course in still further embodiments, the data 206 need not necessarily be subsequently copied in a separate replication process, but could instead trickle over or be sent over to the destination site 204 on an as-needed or as-requested basis. In this regard, time, cost, and bandwidth usage associated with the replication process can be significantly reduced or spread over a larger span of time. This type of trickle replication would be suitable for any of the various embodiments disclosed herein, including those additional embodiments described below.

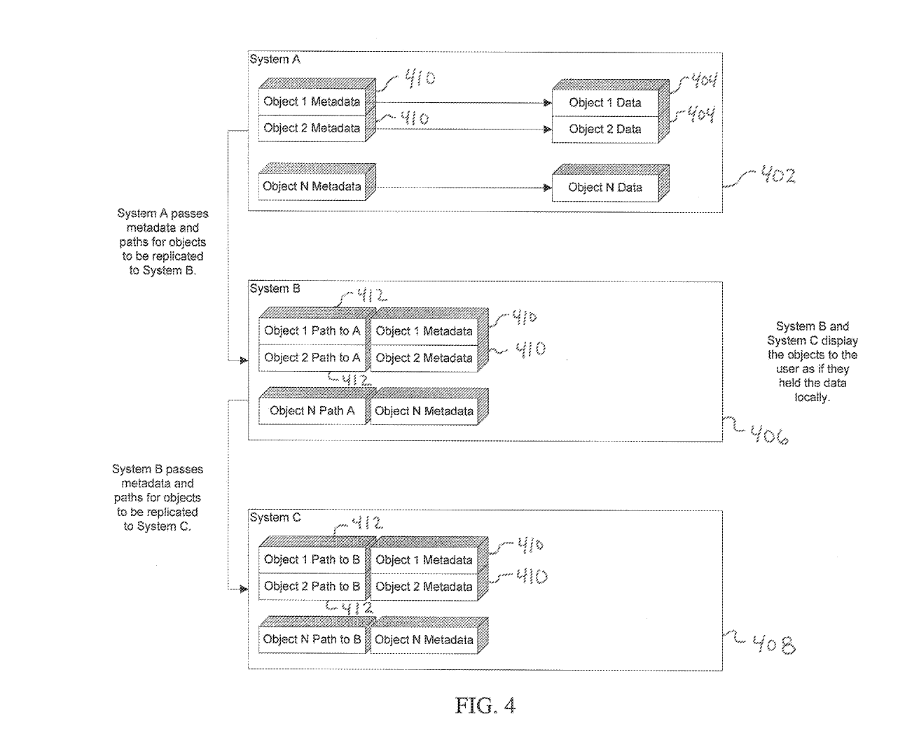

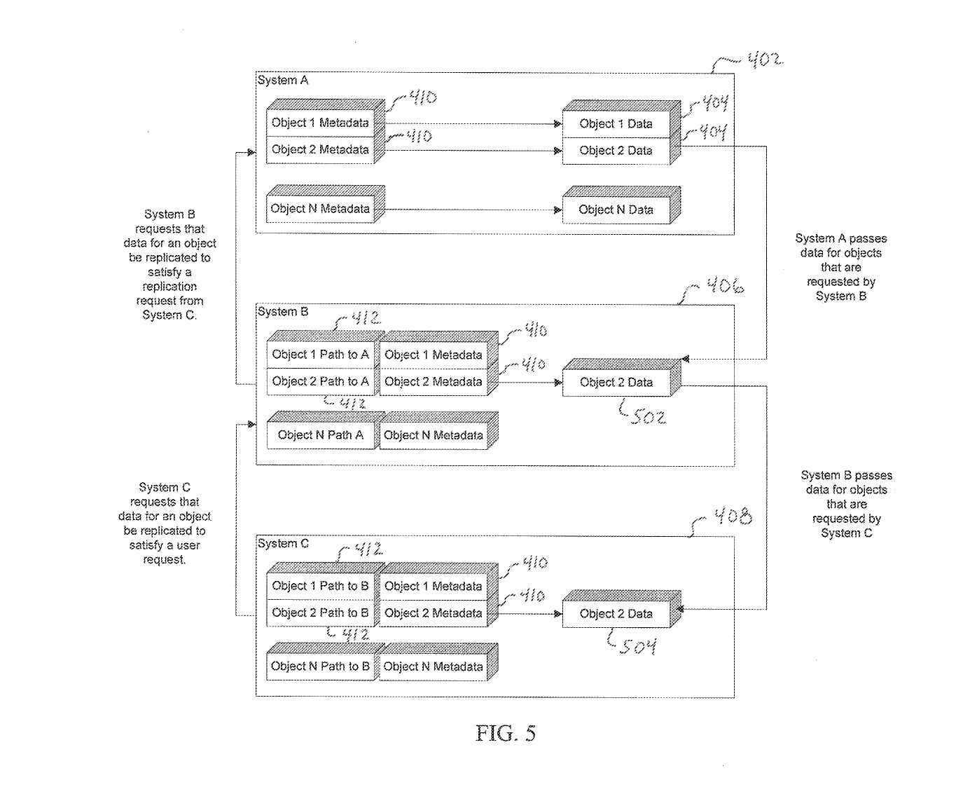

In further embodiments, illustrated in FIGS. 4 and 5, source reference replication permits chaining of replication sites or replication processes. In one example embodiment, a source site 402 may replicate its data 404 or a portion thereof to a first destination site 406, which may then act as a source for replicating the same or different data to a second destination site 408.

As described with respect to one instance of replication, prior to data 404 being sent from the source site 402, or at the initial outset of the transfer or even sometime during the transfer, the source site may send metadata 410 to the first destination site 406 that provides information about or otherwise describes the corresponding data that will be, or is being, replicated or sent to the first destination site, as illustrated in FIG. 4. In addition to any other desirable or suitable information, described above, the metadata 410 may also include a path or path identifier 412 that identifies the location of, or a path to, the data 404 at the source site 402, and thus can be used or followed by the first destination site 406 in order to access the data at the source site until the data has been replicated to the first destination site. As noted above, the metadata 410 transmitted to the first destination site 406 will generally be enough to allow the first destination site to describe the expected data 404 to any potential user of the data at the first destination site, appearing to the user as if the first destination site actually stored the data locally, but without, in fact, requiring the data to actually be at the first destination site.

Accordingly, the first destination site 406 can generally, at any time during the replication process, present the data to be, or being, replicated to its users based on the information available from the sent metadata 410. If a request for the data 404 is made at or through the first destination site 406 from one of its users, and the data has not yet been replicated to the first destination site, the first destination site may utilize the path or path identifier 412, and potentially any other information available from the metadata, to access and retrieve the data 404 from the source site 202, as illustrated in FIG. 5. The accessed and retrieved data 404 may be copied 502 and stored locally at the first destination site 406 for further local access. In this regard, the first destination site can, from then on, present the data to the user locally, and, although not required in all embodiments, should change the metadata 410 at the first destination site or other indicator to reflect that the data 404 has been replicated. The source site 402 may also be notified that the data 404 has been replicated so as to avoid the data being sent a second time and wasting bandwidth. Once the metadata 410 has been sent, or in some embodiments is in the process of being sent, to the first destination site 406, the source site 402 may begin transmitting the actual replication data 404 to the first destination site, as discussed above.

In a similar manner, in a chained replication system as illustrated, prior to data 404 being sent from the first destination site 406, or at the initial outset of the transfer or even sometime during the transfer, the first destination site or the source site 402 may send metadata 410 to the second destination site 408 that provides information about or otherwise describes the corresponding data that will be, or is being, replicated or sent to the second destination site. As described in detail above, in addition to any other desirable or suitable information, the metadata 410 may also include a path or path identifier 412 that identifies the location of, or a path to, the data at either the first destination site 404 or the source site 402, and thus can be used or followed by the second destination site 408 in order to access the data at the first destination site or source site until the data has been replicated to the second destination site. As with the embodiments described above, the metadata 410 transmitted to the second destination site 408 will generally be enough to allow the second destination site to describe the expected data 404 to any potential user of the data at the second destination site, appearing to the user as if the second destination site actually stored the data locally, but without, in fact, requiring the data to actually be at the second destination site.

Accordingly, the second destination site 408 can generally, at any time during the replication process, present the data to be, or being, replicated to its users based on the information available from the sent metadata 410. If a request for the data 404 is made at or through the second destination site 408 from one of its users, and the data has not yet been replicated to the second destination site, the second destination site may utilize the path or path identifier 412, and potentially any other information available from the metadata, to access and retrieve the data 404. At a more generalized level, if at any time, data is requested by a user that has not yet been replicated to its local site, the local site may request the data from its immediate source; if its immediate source also does not yet have the replicated data, the immediate source may request it from its source, and so on. However, it is recognized that any destination site may otherwise request, access, and retrieve the data from any prior source where the data is available based on path information provided in the metadata 410. The accessed and retrieved data may be copied 504 and stored locally at the second destination site 408 for further local access. In this regard, the second destination site 408 can, from then on, present the data to the user locally, and, although not required in all embodiments, should change the metadata 410 at the second destination site or other indicator to reflect that the data 404 has been replicated. The first destination site 402, or other source site from which replication is being performed, may also be notified that the data 404 has been replicated so as to avoid the data being sent a second time and wasting bandwidth. Once the metadata 410 has been sent, or in some embodiments is in the process of being sent, to the second destination site 408, the first destination site 406 or other source site from which replication is being performed, may begin transmitting the actual replication data 404 to the second destination site, as discussed above.

In general, because each site may forward its received metadata to a subsequent destination site in a chain replication system, as illustrated in FIGS. 4 and 5, each destination site, including the final destination site, may present the data to its users as if the replicated data was immediately stored locally. If at any time, data that has not yet been replicated to a destination site is requested by a user at that destination site, the destination site can request the data from its source, and the request can be forwarded all the way up to the original source destination, if necessary. Thus, source reference replication according to the various embodiments of the present disclosure permit replication efficiencies not yet before obtained with conventional replication techniques.

Indeed, the various embodiments of the present disclosure relating to source reference replication provide significant advantages over conventional systems and methods for data replication. For example, the various embodiments of the present disclosure may reduce cost in a variety of ways, including but not limited to: reducing total bandwidth congestion; reducing visible replication time; reducing the need for physically transporting replicated data, and increasing immediate access to the replicated data at the destination site.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A method of data replication from a first data storage device to a second data storage device, the method comprising prior to replicating data from the first data storage device to the second data storage device, transmitting metadata relating to data to be replicated to the second data storage device, the metadata including information about the data to be replicated and a path identifier identifying a path through which the second data storage device can remotely access the data at the first data storage device until the data to be replicated is copied to the second data storage device.

2. The method of claim 1, further comprising copying the data to be replicated to the second data storage system.

3. The method of claim 1, wherein the first data storage device is located at a source site and the second data storage device is located a remote destination site.

4. The method of claim 3, further comprising, upon request from a user to the destination site to access the data to be replicated when the data to be replicated has not yet been copied to the second data storage device, remotely accessing the data at the first data storage device utilizing the path identifier provided in the metadata.

5. The method of claim 4, further comprising retrieving and locally storing a copy of the data accessed utilizing the path identifier, and indicating in the metadata that such data has been replicated to the second data storage device.

6. The method of claim 5, further comprising notifying the source site that the retrieved data has been replicated to the second data storage device.

7. The method of claim 6, further comprising copying, to the second data storage device, a portion of the data to be replicated that has not been identified as already retrieved and replicated to the second data storage device.

8. The method of claim 1, wherein the metadata is transmitted via a computer network.

9. An information handling system comprising a first data storage subsystem and a second data storage subsystem, the first data storage subsystem comprising data to be replicated to the second data storage subsystem, and the second data storage subsystem comprising metadata including information about the data to be replicated and a path identifier for remotely accessing the data at the first data storage subsystem until the data to be replicated is copied to the second data storage subsystem.

10. The information handling system of claim 9, wherein the first data storage subsystem and second data storage subsystem are remotely connected via a computer network and the metadata at the second data storage subsystem was transmitted from the first data storage subsystem via the network.

11. The information handling system of claim 10, wherein, upon request from a user to the second data storage subsystem for access to the data to be replicated, the data at the first data storage subsystem is accessed by the second data storage subsystem via the computer network utilizing the path identifier provided in the metadata.

12. The information handling system of claim 11, wherein data accessed by the second data storage subsystem via the computer network utilizing the path identifier provided in the metadata is retrieved and locally stored at the second data storage subsystem, and the metadata is updated to reflect that such data has been replicated to the second data storage subsystem.

13. The information handling system of claim 12, wherein for the data retrieved and locally stored at the second data storage subsystem, the first data storage subsystem is notified that the retrieved data has been replicated to the second data storage subsystem.

14. The information handling system of claim 12, wherein during a subsequent replication process for the data to be replicated, wherein the data to be replicated is copied to the second data storage subsystem, the data previously retrieved and locally stored at the second data storage subsystem is removed from the replication process, so as not be recopied to the second data storage subsystem.

15. A method for chaining data replication between a plurality of data storage subsystems, the plurality of data storage subsystems comprising a plurality of source-destination subsystem pairs, such that for each pair a first data storage subsystem is a source and a second data storage subsystem is a destination, the method comprising, for each source-destination subsystem pair, prior to replicating data from the first data storage subsystem to the second data storage subsystem, transmitting metadata relating to data to be replicated to the second data storage subsystem, the metadata including information about the data to be replicated and a path identifier identifying at least a portion of a full path through which the second data storage device can remotely access the data until the data to be replicated is copied to the second data storage device.

16. The method of claim 15, wherein the at least a portion of a path comprises a path to the first data storage subsystem.

17. The method of claim 16, wherein any remainder of the full path through which the second data storage device can remotely access the data comprises a path identified by metadata at the first data storage subsystem.

18. The method of claim 17, wherein the first data storage subsystem is a source in a first source-destination subsystem pair and is a destination in a second source-destination subsystem pair, and the path identified by metadata at the first data storage subsystem comprises a path to a third data storage subsystem being a source in the second source-destination subsystem pair.

19. The method of claim 16, further comprising copying the data to be replicated to the second data storage system.

20. The method of claim 15, further comprising, upon request from a user to the second data storage subsystem to access the data to be replicated when the data to be replicated has not yet been copied to the second data storage device, remotely accessing the data via the full path.
